(19) United States
(12) Patent Application Publication
(10) Pub. No.: US 2015/0066598 A1
(43) Pub. Date: Mar. 5, 2015

(54) PREDICTING SERVICE DELIVERY COSTS UNDER BUSINESS CHANGES

(71) Applicant: International Business Machines Corporation, Armonk, NY (US)

(72) Inventors: Joel W. Branch, Hamden, CT (US); Yixin Diao, White Plains, NY (US); Emi K. Olsson, Germantown, NY (US); Larisa Shwartz, Scarsdale, NY (US); Li Zhang, Yorktown Heights, NY (US)

(21) Appl. No.: 14/015,293

(22) Filed: Aug. 30, 2013

(51) Int. Cl. G06Q 10/06

(52) U.S. Cl. CPC G06Q 10/06375
USPC 705/7.37

(57) ABSTRACT

A method for predicting service delivery costs for a changed business requirement including detecting an infrastructure change corresponding to the changed business requirement affecting a computer server, deriving a service delivery workload change of the computer server from the infrastructure change, and determining a service delivery cost of the computer server based on the service delivery workload change.

### BACKGROUND

The present disclosure relates to predicting service delivery workforce under business changes, and more particularly to predicting service delivery effort time and labor cost.

In a service delivery environment, service customers desire to understand the impact of business changes to service delivery labor cost. Examples of changes include increased number of users, architecture changes, new business applications, and new infrastructure/servers. In addition, from the service providers' perspective, it is also desired to have quantitative understanding of the impact of customer change requests to the service agent workload.

### BRIEF SUMMARY

According to an exemplary embodiment of the present disclosure, a method for predicting service delivery costs for a changed business requirement including detecting, by a processor, an infrastructure change corresponding to said changed business requirement, deriving, by said processor, a service delivery workload change from said infrastructure change, and determining, by said processor, a service delivery cost based on said service delivery workload change.

According to an exemplary embodiment of the present disclosure, a method for predicting service delivery workloads includes generating a discrete event simulation model, and outputting a cost prediction based on the discrete event simulation model, wherein the cost prediction corresponds to a change in a service delivery process.

According to an exemplary embodiment of the present disclosure, methods are implemented in a computer program product for predicting service delivery workloads, the computer program product including a computer readable storage medium having computer readable program code embodied therewith, the computer readable program code being configured to perform method steps.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a diagram of a system architecture supporting a method for workforce prediction according to an exemplary embodiment of the present disclosure;

FIG. 2 is a flow diagram of a reconciliation method for effort prediction according to an exemplary embodiment of the present disclosure;

FIG. 3 is a flow diagram of a method for classifying customer tickets based on complexity according to an exemplary embodiment of the present disclosure;

FIG. 4 is a flow diagram of a method for predicting effort time from customer workload and claim data according to an exemplary embodiment of the present disclosure;

FIG. 5 is a flow diagram of a method for assessing effort prediction quality according to an exemplary embodiment of the present disclosure;

FIG. 6 is a flow diagram of a method for cost prediction according to an exemplary embodiment of the present disclosure; and

FIG. 7 is a diagram of a system configured to predict service delivery metrics according to an exemplary embodiment of the present disclosure.

### DETAILED DESCRIPTION

Described herein are exemplary model based approaches for service delivery workforce prediction under business changes. Some embodiments of the present disclosure use detailed business, IT (Information Technology), and service delivery mapping and modeling for predicting a cost impact.

Service delivery workforce prediction can be implemented in cases where, for example, a client wants to understand the impact of business changes to service delivery. These changes include changing (e.g., increasing) number of users, architecture changes, new business applications, new infrastructure/servers, etc. Some embodiments of the present disclosure relate to quantitative what-if analytics for client decision-making and service delivery change management.

Embodiments of the present disclosure relate to methods for a service delivery workforce prediction solution. In some embodiments the prediction is based on tickets, where tickets are issued as part of a tracking system that manages and maintains one or more lists of issues, as needed by an organization delivering the service.

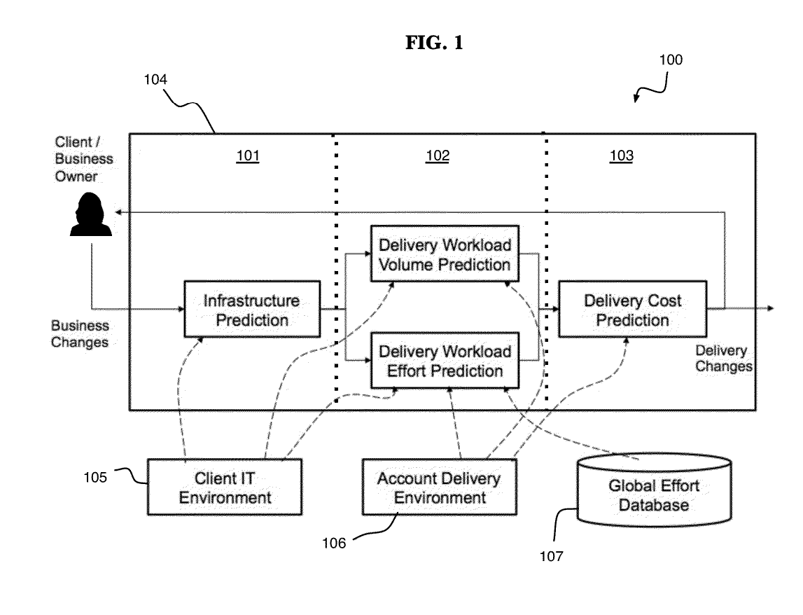

Referring to FIG. 1, within an exemplary system architecture 100 supporting a method for workforce prediction 104, exemplary methods comprise understanding the IT infrastructure changes due to business requirement changes 101, deriving the service delivery workload changes from the IT infrastructure changes 102, and determining the Service Level Agreement (SLA) driven service delivery cost changes from the service delivery workload changes 103.

At block 101, a queuing model based approach is applied at an IT-level (e.g., number of servers, number of requests, server utilization, request response time). The queuing model based approach models infrastructure as a system including a server receiving requests corresponding to tickets. The server provides some service to the requests. The requests arrive at the system to be served. If the server is idle, a request is served immediately. Otherwise, an arriving request joins a waiting line or queue. When the server has completed serving a request, the request departs. If there is at least one request waiting in the queue, a next request is dispatched to the server. The server in this model can represent anything that performs some function or service for a collection of requests.

At block 102, a workload volume prediction module and a workload effort prediction module are applied.

According to an exemplary embodiment of the present disclosure, the workload volume prediction module predicts event/ticket volumes using a model of IT system configuration, load, and performance data. For example, the workload volume prediction includes a correlation of data including: (1) historical system loads, such as the amount, rate, and distribution of requests for a given resource (e.g., software or service); (2) historical system performance measurements (such as utilization and response time) associated with the system loads; (3) application/infrastructure configurations such as software/hardware configurations (e.g., CPU type, memory); and (4) historical system event (e.g., alerts) and/or ticket data (e.g., incidents and alerts) associated with the operation of IT infrastructure elements that are associated with the data above.

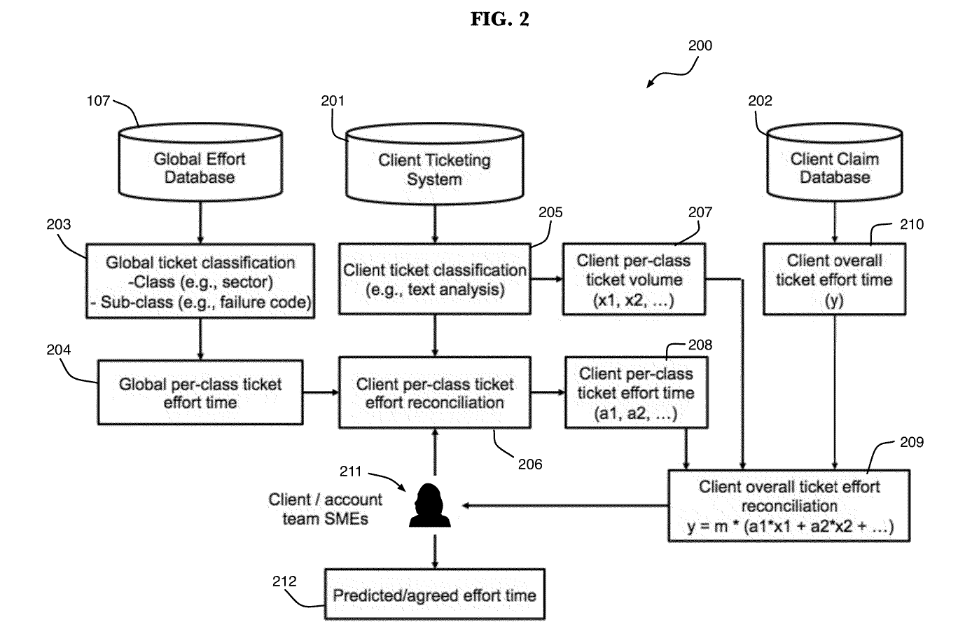

According to an exemplary embodiment of the present disclosure, the workload effort prediction module further comprises a reconciliation method (see FIG. 2) for service delivery effort prediction.

In addition, at block 103, a discrete event simulation based approach is applied, at service delivery (e.g., number of Service Agreements (SAs), number of tickets, effort time, SLA attainment), which further comprises a simplified and self-calibrated method for cost prediction (see FIG. 6).

The architecture 100 of FIG. 1 further includes a client IT environment 105, an account delivery environment 106, and a global effort database 107, as data sources for the workforce prediction at block 104.

Referring to FIG. 2, a reconciliation method for effort prediction 200 according to an exemplary embodiment of the present disclosure uses data from the global effort database 107, a client ticketing data 201 and a client claim data 202. At block 206, a client per-class ticket effort reconciliation is determined. This determination is based on a global per-class ticket effort time (see block 204), a client ticket classification (see block 205) and input from a client (see 211).

At block 203, the method includes global ticket classification. Referring to block 101 of FIG. 1 and FIG. 3, the classification of customer tickets is based on complexity 300 according to an exemplary embodiment of the present disclosure. Given an ISM dispatch 301, an incident description 302 and a complexity 303 are determined. The incident description 302 and the complexity 303 are input into a classifier 304 for classifier training. The classifier 304 is input into a complexity classification model 305. Further, the complexity classification model 305 receives an incident description 306 from the client ticketing data 201. The complexity classification model 305 outputs a complexity of the customer ticket at 307.

Referring to FIG. 2, the ticket can be classified by the complexity classification model 305 according to, for example, a sector, and sub-classified according to a failure code. At block 204, a global per-class ticket effort time is determined given the ticket classifications.

The client ticket classification (see block 205) is based on the client ticketing data 201, and outputs a client per-class ticket volume at block 207. The client per-class ticket volume is used to determining a client overall ticket effort reconciliation at 209 given a client overall ticket effort time 210 determined from the client claim data 202.

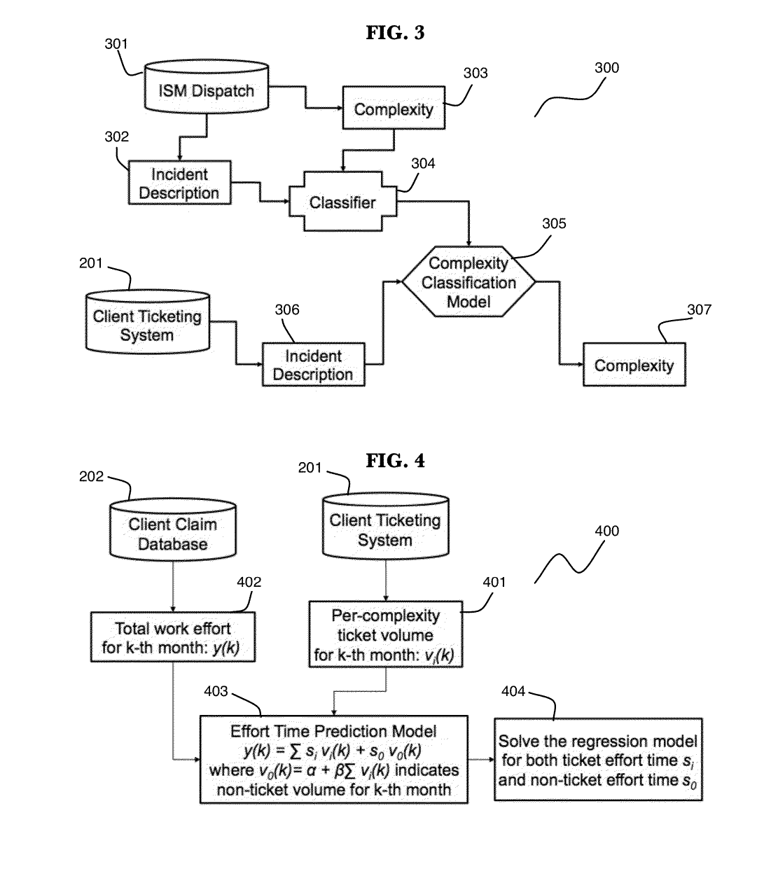

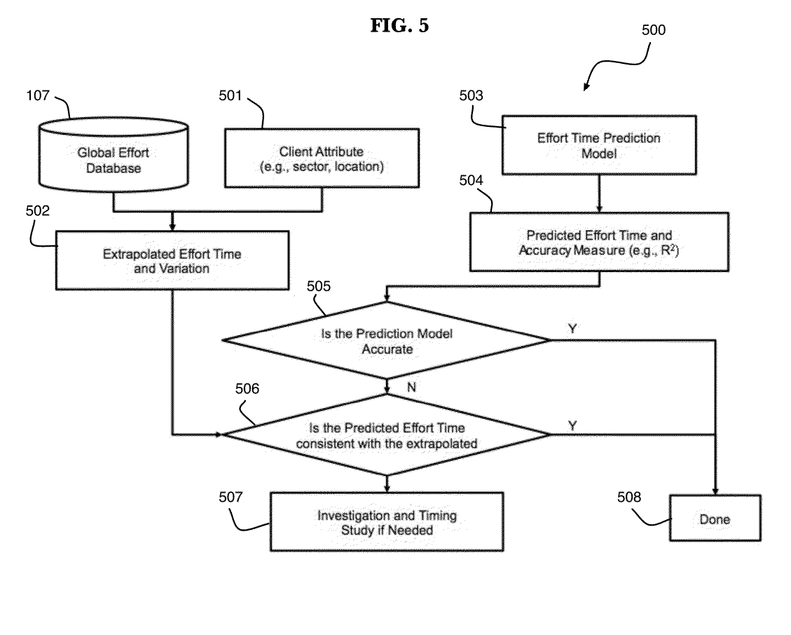

Referring to block 102 of FIG. 1 and FIG. 4 and an exemplary method for predicting effort time from customer workload and claim data 400, the client ticketing data 201 and client claim data 202 are used to determining a per-complexity ticket volume for some time period 401 (e.g., for a k-th month: vᵢ(k)) and a total work effort for the time period 402 (e.g., for the k-th month: y(k)), respectively. The effort time prediction model y(k)=Σsᵢvᵢ(k)+s₀v₀(k), where v₀(k)=α+βΣvᵢ(k) indicates non-ticket volume for k-th month. Herein α and β are calibration parameters that can be solved by a regression model, where β indicates how the non-ticket volume correlates to the ticket volume and a indicates the part of the non-ticket work that has no correlation to the ticket volume. The total work effort for the time period 402 is used to solve the regression model for both ticket effort time sᵢ non-ticket effort time s₀.

According to an exemplary embodiment of the present disclosure, the client overall ticket effort reconciliation at 209 can be used by the client 211 to determine the predicted or agreed to effort time at block 212.

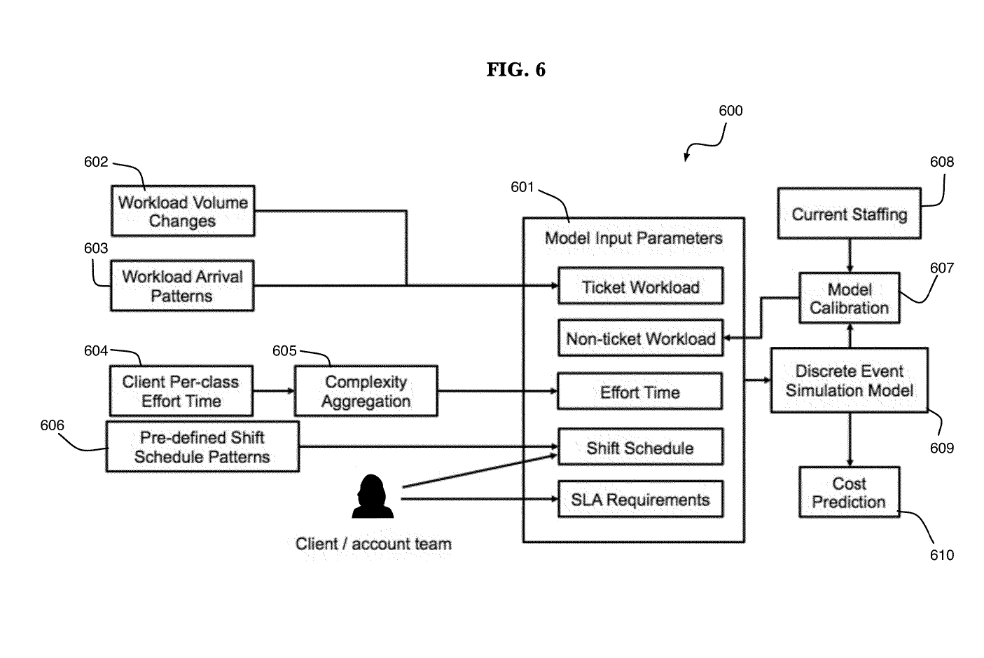

Referring to block 103 of FIG. 1 and FIG. 5, in an exemplary method for assessing effort prediction quality, an effort time and variable 500 are extrapolated from the global effort data 107 and a client attribute 501. Further, an effort time and accuracy measure (e.g., R²) are predicted at block 504 given an effort time prediction model (see block 503). If the prediction model is determined not to be accurate at block 505 (e.g., the R² accuracy measure is less than 0.9), then the method includes determining whether the predicted effort time is consistent with the extrapolated effort time (see block 502) at block 506. Similarly, the R² accuracy measure can be used to quantify the consistency as disclosed above. If the predicted effort time is not consistent with the extrapolated effort time, then an investigation and timing study can be performed at block 507. If an affirmative determination is made at either block 505 or block 506, then the method ends at block 508.

Referring now to FIG. 6 and an exemplary service delivery effort prediction and a simplified and self-calibrated method for cost prediction 600, a model of input parameters 601 is determined from a plurality of input data. In some exemplary embodiments, the input data includes workload volume changes 602, workload arrival patterns 603, client per-class effort time 604 and complexity aggregation 605, and pre-defined shift schedule patterns 606.

In some exemplary embodiments, the model of input parameters 601 includes ticket workload based on the workload volume changes 602 and the workload arrival patterns 603, effort time based on the client per-class effort time 604 and the complexity aggregation 605, and a shift schedule based on the pre-defined shift schedule patterns 606 and client input. The model of input parameters 601 can also include Service Level Agreements based on client input. The model of input parameters 601 can also include a non-ticket workload. The non-ticket workload can be calibrated by a model calibration (see block 607). The model calibration 607 can be determined based on current conditions 608 (e.g., a level of staffing) and an output of the model of input parameters 601, including a discrete event simulation model 609. Further, in some exemplary embodiments the discrete event simulation model 609 outputs a cost prediction 610.

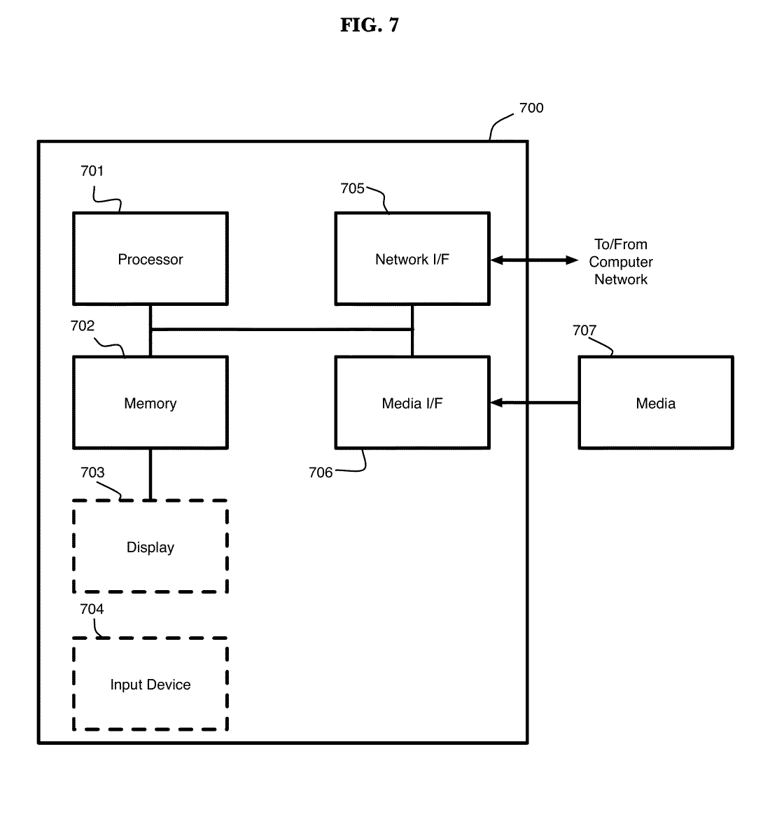

By way of recapitulation, according to an exemplary embodiment of the present disclosure, a method for predicting service delivery costs for a changed business requirement includes detecting, by a processor (see for example, FIG. 7, block 701), an infrastructure change corresponding to said changed business requirement (see for example, FIG. 1, block 101), deriving, by said processor, a service delivery workload change from said infrastructure change (see for example, FIG. 1, block 102), and determining, by said processor, a service delivery cost (e.g., staffing costs) based on said service delivery workload change (see for example, FIG. 1, block 103 and FIG. 6, block 610).

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Furthermore, it should be noted that any of the methods described herein can include an additional step of providing a system for reconciliation methodology for effort prediction (see for example, FIG. 1) comprising distinct software modules embodied on one or more tangible computer readable storage media. All the modules (or any subset thereof) can be on the same medium, or each can be on a different medium, for example. The modules can include any or all of the components shown in the figures. In a non-limiting example, the modules include a first module that performs an analysis of the IT infrastructure changes due to business requirement changes (see for example, FIG. 1: 101), a second module that derives the service delivery workload changes from the IT infrastructure changes (see for example, FIG. 1: 102); and a third module that determines the SLA-driven service delivery cost changes from the service delivery workload changes (see for example, FIG. 1: 103). Further, a computer program product can include a tangible computer-readable recordable storage medium with code adapted to be executed to carry out one or more method steps described herein, including the provision of the system with the distinct software modules.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 7 is a block diagram depicting an exemplary computer system for predicting service delivery workloads according to an embodiment of the present disclosure. The computer system shown in FIG. 7 includes a processor 701, memory 702, display 703, input device 704 (e.g., keyboard), a network interface (I/F) 705, a media IF 706, and media 707, such as a signal source, e.g., camera, Hard Drive (HD), external memory device, etc.

In different applications, some of the components shown in FIG. 7 can be omitted. The whole system shown in FIG. 7 is controlled by computer readable instructions, which are generally stored in the media 707. The software can be downloaded from a network (not shown in the figures), stored in the media 707. Alternatively, a software downloaded from a network can be loaded into the memory 702 and executed by the processor 701 so as to complete the function determined by the software.

The processor 701 may be configured to perform one or more methodologies described in the present disclosure, illustrative embodiments of which are shown in the above figures and described herein. Embodiments of the present disclosure can be implemented as a routine that is stored in memory 702 and executed by the processor 701 to process the signal from the media 707. As such, the computer system is a general-purpose computer system that becomes a specific purpose computer system when executing the routine of the present disclosure.

Although the computer system described in FIG. 7 can support methods according to the present disclosure, this system is only one example of a computer system. Those skilled of the art should understand that other computer system designs can be used to implement the present invention.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A method for predicting service delivery costs for a changed business requirement, the method comprising:
detecting, by a processor, an infrastructure change corresponding to said changed business requirement;
deriving, by said processor, a service delivery workload change from said infrastructure change; and
determining, by said processor, a service delivery cost based on said service delivery workload change.

2. The method of claim 1, wherein deriving said service delivery workload change further comprises:
performing a workload volume prediction; and
performing a workload effort prediction.

3. The method of claim 2, wherein said workload effort prediction further comprises an effort reconciliation method comprising:
classifying a customer service request workload based on a complexity of one or more requests;
predicting a workload request effort time from customer workload volume data and service delivery labor claim data; and
assessing effort prediction quality using historical effort timing study data.

4. The method of claim 3, wherein classifying said customer service request workload based on said complexity of said one or more requests further comprises:
building a complexity classification model based on historical workload request description data and request complexity data;
extracting incident description data from said one or more requests; and
deriving said complexity based on the said complexity classification model and the said workload request description data.

5. The method of claim 3, wherein said predicting said workload request effort time from said customer workload volume data and said service delivery labor claim data further comprises:
obtaining a total workload effort from said service delivery labor claim data for multiple periods of time;
obtaining per complexity customer workload volume data for the said multiple periods of time;
building an effort time prediction model configured to predict said total workload effort from said per complexity customer workload volume data; and
deriving said workload request effort time from the said effort time prediction model.

6. The method of claim 3, wherein said assessing effort prediction quality using historical effort timing study data further comprises:
extrapolating said effort time from historical effort timing study data based on customer specific attributes;
obtaining the customer workload request effort time from the said effort time prediction model;
comparing said workload request effort time predicted from customer workload volume data and service delivery labor claim data to said effort time; extrapolated from said effort time from historical effort timing study data based on said customer specific attributes; and
accepting said predicted effort time upon comparison to a criteria.

7. A computer program product for predicting service delivery workloads comprising:
a computer readable storage medium having computer readable program code embodied therewith, the computer readable program code comprising:
computer readable program code configured to determine an infrastructure change corresponding to said changed business requirement;
computer readable program code configured to derive a service delivery workload change from said infrastructure change; and
computer readable program code configured to determine a service delivery cost based on said service delivery workload change.

8. The computer program product of claim 5, wherein computer readable program code configured to derive said service delivery workload change further comprises:
computer readable program code configured to perform a workload volume prediction; and
computer readable program code configured to perform a workload effort prediction.

9. The computer program product of claim 6, wherein said computer readable program code configured to perform said workload effort prediction further comprises computer readable program code configured to perform an effort reconciliation comprising:
computer readable program code configured to perform classify a customer service request workload based on a complexity of one or more requests;
computer readable program code configured to perform predict a workload request effort time from customer workload volume data and service delivery labor claim data; and
computer readable program code configured to perform assess effort prediction quality using historical effort timing study data.

10. The computer program product of claim 9, wherein said computer readable program code configured to classify said customer service request workload based on said complexity of said one or more requests further comprises:
computer readable program code configured to build a complexity classification model based on historical workload request description data and request complexity data;
computer readable program code configured to extract incident description data from said one or more requests; and
computer readable program code configured to derive said complexity based on the said complexity classification model and the said workload request description data.

11. The computer program product of claim 9, wherein said computer readable program code configured to predict said workload request effort time from said customer workload volume data and said service delivery labor claim data further comprises:
computer readable program code configured to obtain a total workload effort from said service delivery labor claim data for multiple periods of time;
computer readable program code configured to obtain per complexity customer workload volume data for the said multiple periods of time;
computer readable program code configured to build an effort time prediction model configured to predict said total workload effort from said per complexity customer workload volume data; and
computer readable program code configured to derive said workload request effort time from the said effort time prediction model.

12. The computer program product of claim 9, wherein said computer readable program code configured to assess effort prediction quality using historical effort timing study data further comprises:
computer readable program code configured to extrapolate said effort time from historical effort timing study data based on customer specific attributes;
computer readable program code configured to obtain the customer workload request effort time from the said effort time prediction model;
computer readable program code configured to compare said workload request effort time predicted from customer workload volume data and service delivery labor claim data to said effort time; extrapolated from said effort time from historical effort timing study data based on said customer specific attributes; and
computer readable program code configured to accept said predicted effort time upon comparison to a criteria.

13. A computer program product for predicting service delivery workloads comprising:
a computer readable storage medium having computer readable program code embodied therewith, the computer readable program code comprising:
computer readable program code configured to generate a discrete event simulation model; and
computer readable program code configured to output a cost prediction based on the discrete event simulation model, wherein the cost prediction corresponds to a change in a service delivery process.

14. The computer program product of claim 13, wherein computer readable program code configured to generate a discrete event simulation model further comprises:
computer readable program code configured to perform a workload volume prediction; and
computer readable program code configured to perform a workload effort prediction.

15. The computer program product of claim 14, wherein said computer readable program code configured to perform said workload effort prediction further comprises computer readable program code configured to perform an effort reconciliation comprising:
computer readable program code configured to perform classify a customer service request workload based on a complexity of one or more requests;
computer readable program code configured to perform predict a workload request effort time from customer workload volume data and service delivery labor claim data; and
computer readable program code configured to perform assess effort prediction quality using historical effort timing study data.

16. The computer program product of claim 14, wherein said computer readable program code configured to classify said customer service request workload based on said complexity of said one or more requests further comprises:
computer readable program code configured to build a complexity classification model based on historical workload request description data and request complexity data;
computer readable program code configured to extract incident description data from said one or more requests; and
computer readable program code configured to derive said complexity based on the said complexity classification model and the said workload request description data.

17. The computer program product of claim 14, wherein said computer readable program code configured to predict said workload request effort time from said customer workload volume data and said service delivery labor claim data further comprises:
computer readable program code configured to obtain a total workload effort from said service delivery labor claim data for multiple periods of time;
computer readable program code configured to obtain per complexity customer workload volume data for the said multiple periods of time;
computer readable program code configured to build an effort time prediction model configured to predict said total workload effort from said per complexity customer workload volume data; and
computer readable program code configured to derive said workload request effort time from the said effort time prediction model.

18. The computer program product of claim 14, wherein said computer readable program code configured to assess effort prediction quality using historical effort timing study data further comprises:
computer readable program code configured to extrapolate said effort time from historical effort timing study data based on customer specific attributes;
computer readable program code configured to obtain the customer workload request effort time from the said effort time prediction model;
computer readable program code configured to compare said workload request effort time predicted from customer workload volume data and service delivery labor claim data to said effort time; extrapolated from said effort time from historical effort timing study data based on said customer specific attributes; and
computer readable program code configured to accept said predicted effort time upon comparison to a criteria.
